(19) United States
(12) Patent Application Publication
(10) Pub. No.: US 2005/0177635 A1
(43) Pub. Date: Aug. 11, 2005

(54) System and method for allocating server resources

(76) Inventors: Roland Schmidt, Vancouver (CA); Xiaomei Tian, Coquitlam (CA); Bobby Cheuk-Yuen Lam, Richmond (CA); Jim Belton, Port Coquitlam (CA)

Correspondence Address: KNOBBE MARTENS OLSON & BEAR LLP, 2040 MAIN STREET, FOURTEENTH FLOOR, IRVINE, CA, 92614, US

(21) Appl. No.: 10/742,618

(22) Filed: Dec. 18, 2003

(51) Int. Cl. G06F 15/173; G06F 15/177

(52) U.S. Cl. 709/226; 709/220; 709/223

(57) ABSTRACT

A system and method for allowing web-based applications to run in a controlled environment. In particular, a method allocates server resources among applications running in a sandbox environment on a web server. Applications which attempt to exceed limits specified in templates associated with the application may be denied access to a resource.

### BACKGROUND OF THE INVENTION

1. Field of the Invention

This invention relates generally to computer servers, and more specifically, to allocating server resources among server instances for responding to client requests. In particular, the invention relates to a framework for allocating web server resources among server instances for responding to http client requests. This invention also relates to frameworks for allowing web-based applications to run in a controlled environment.

2. Description of the Related Art

In the World Wide Web of the Internet, client machines perform transactions with Web servers using the Hypertext Transfer Protocol (HTTP), which is an application protocol providing users access to data (e.g., text, graphics, images, sound, video, etc.) using a standard language known as Hypertext Markup Language (HTML). HTML provides basic formatting and allows the document to specify hyperlinks to other documents on the same or other servers. The document access method and document name is specified using a Uniform Resource Locator (URL).

End users use HTML-compatible web browsers (e.g., Netscape Navigator or Microsoft Internet Explorer) on client machines to access Web pages. The user specifies a document via its URL. The client machine then makes a request to the server identified in the link and receives a document in response, which it displays to the user.

Many types of information need to be updated more frequently than is practical if the information is stored on the web server in static files. This has led to web servers being extended to support “dynamic content.” The first such extension was the Common Gateway Interface (CGI). CGI is a World Wide Web standard allowing the HTML functionality of a Web server to be extended using external programming scripts or executables. CGI programs are typically used to return dynamic information and to respond to HTTP browser requests by a user through HTML forms.

A desire to reduce the overhead of executing independent scripts has led to the integration of script execution environments directly into web servers. ASP (Active Server Pages), PHP (PHP: Hypertext Preprocessor), Perl and Java environments have each been integrated in web servers to largely replace CGI. When a request arrives from a client web browser, the web server determines the type of content requested. In the case of a static web page (whose text does not change) such as an image, the web server simply transmits the file to the client's web browser using the HTTP protocol. In the case of a dynamic web page, the web server passes the URL and other HTTP request parameters to the script execution environment, which executes the script or program and returns the resulting data to the client, again using HTTP.

Internet Service Providers (ISPs) host multiple organizations' web sites on a single Web server. However, rather than using a subset of the ISP's domain, most organizations prefer to use their own individualized domain name. An ISP may provide web services for multiple domain names using a multi-homed web server that responds to requests made to multiple addresses. Web addresses that are served only by a multi-homed server, with no dedicated server are referred to as virtual hosts.

The virtual hosting capabilities of existing servers are typically quite limited. For example, although different customers may have different needs and desire different levels of service, in existing multi-homed servers, the functionality offered by the server is typically the same for each customer.

Web servers have evolved from merely hosting web sites to becoming full-fledged application servers. For example, the Tomcat JSP/Servlet Container technology may be used to host execution of Java programming language applications on a web server. The Tomcat Manager allows control over independent applications, and Tomcat can support multiple applications for a single virtual host. An application in this context is a set of functions executed on the web server, which can be invoked by web clients issuing HTTP requests using the same or similar URLs.

Some existing web servers provide a security framework, such as the Java based security manager. For example, the Tomcat web server can receive a request for service, determine the application, and dynamically set the security level to be used by the application. Security policies for each security level can be defined in a text file, and different classes can be assigned different security levels. A class is a collection of related data (members) and functions (methods) that operate on those data. However, the security features provided by Java are limited. In addition to being limited to applications written in Java, the Java framework provides only a high level of access control based upon access to specific functionality. Moreover, while frameworks such as provided by Java control some types of resources that an application may access, they do not provide a general mechanism for controlling the type and amount of resources that an application may consume. Thus, server application frameworks that provide better ways to limit and allocate access to server resources are needed.

### SUMMARY OF THE INVENTION

The system, method, and devices of the present invention each have several aspects, no single one of which is solely responsible for its desirable attributes. Without limiting the scope of this invention as expressed by the claims that follow, its more prominent features will now be discussed briefly. After considering this discussion, and particularly after reading the section entitled “Detailed Description of the Embodiments of the Invention” one will understand how the features of this invention provide advantages, which include allocating server resources such as network bandwidth, memory, and CPU time, and controlling access to functionality.

One embodiment is a web server system comprising a server computer having installed thereon a web server and a plurality of applications that interoperate with the web server to service requests from web browsers. The system may further comprise a plurality of templates, each template being associated with one or more of the applications, and specifying resource usage restrictions for the execution of such applications, such that different resource usage restrictions are placed on different applications. An application framework may run on the server computer in association with the web server and may enforce the resource usage restrictions specified by the templates. An application management interface may provide functionality for an administrator to edit the plurality of templates, and to create new templates, to control execution of the plurality of applications on the server computer. Preferably, the application framework enforces the resource usage restrictions, at least in part, by intercepting function calls made to the web server by the applications.

Another embodiment is a method for allocating resources in a server computer. The method comprises receiving a web server request from a client for dynamic content. Preferably, the web server request comprises a URL. An application for generating the dynamic content is identified. Preferably, the identification of the application is based, at least in part, on the URL. A template for the application is identified. Preferably, the template associates at least one resource with a limit. The application is executed in a virtual machine configured to allow resource accessing function calls to be intercepted. Resource accessing function calls are intercepted. Access to the resource is granted if the limit is not exceeded. Resource usage is tracked.

Still another embodiment is a method for allocating resources in a server computer. The method comprises receiving a request from a client. An application is identified based, at least in part, on the request. At least one association of a resource with a limit specific to the application is identified. The application is executed in a virtual machine configured to limit access to the resource as specified by the limit.

Another embodiment is a method for selecting a substitute resource template for an application. The method comprises identifying a template defining a limit on at least one resource in a first server associated with an application. The associated template is compared to a set of available templates provided for a second server. The available template that is a closest match to the associated template is selected.

Another embodiment is system for allocating resources in a server computer. The system comprises a virtual machine module configured to execute a computer application associated with a server request. An application definitions module is configured to identify a mapping of at least one resource template with the application. A parameter template module is configured to identify a template associated with the application, wherein the template associates at least one resource with a limit. A framework module is configured to intercept function calls of the application that are associated with the resource and to limit access to the resource as specified by the limit of the template.

Still another embodiment is a system for allocating resources for processing of a client request to a server computer. The system includes a means for identifying an application based, at least in part, on the request; a means for identifying at least one association of a resource with a limit for the application; a means for executing the application; and a means for limiting access to the resource as specified by the limit.

Another embodiment is a method for allocating resources in a server computer. The method comprises receiving a signal to activate an application. An application is identified based, at least in part, on the signal. At least one association of a resource with a limit specific to the application is identified. The application is executed in a virtual machine configured to limit access to the resource as specified by the limit.

### BRIEF DESCRIPTION OF THE DRAWINGS

FIG. 1 is a simplified block diagram of one embodiment of a system for performing allocation of server resources in a web server.

FIG. 2 is a simplified block diagram of another embodiment of a system for performing allocation of server resources in a web server similar to that depicted in FIG. 1 adapted to a clustered server environment.

FIG. 3 is a flow chart depicting one embodiment of a method of allocating server resources in a system as depicted in FIG. 1.

FIG. 4 depicts a data flow diagram that illustrates the flow of data in one embodiment of a system of FIG. 1.

FIG. 5 is a simplified data flow diagram illustrating the relationship between a web request and one embodiment of the system of FIG. 1.

FIG. 6 illustrates the flow of data in an embodiment of a method according to FIG. 5 in which is configured to support the PHP scripting language.

FIG. 7 is a screen shot illustrating a web-based interface page for configuring allowed functionality in one embodiment of the system of FIG. 1.

FIG. 8 is a screen shot illustrating a web-based interface page for configuring resource allocation in one embodiment of the system of FIG. 1.

FIG. 9 is a screen shot illustrating a web-based interface page for configuring bandwidth resource allocation in one embodiment of the system of FIG. 1.

### DETAILED DESCRIPTION OF THE EMBODIMENTS OF THE INVENTION

The following detailed description is directed to certain specific embodiments of the invention. However, the invention can be embodied in a multitude of different ways as defined and covered by the claims. In this description, reference is made to the drawings wherein like parts are designated with like numerals throughout.

A. Overview

Web-based applications may be provided using a single virtual machine running on a web server. This type of system has a number of different problems. Applications may call functions or methods that interfere with other applications or the web server. Applications may use up too many local resources or too many network resources (e.g. send too many messages).

When multiple web-based applications are running on a web server, one application may call functions or methods that have undesired effects on the other applications. For example, an application might delete the files of another application or cause the web server to stop running. The Java security manager gives explicit control over which classes can have their methods executed under a specific security policy, but there are no equivalent mechanisms for other web-based application environments.

Moreover, simply blocking functions or methods is too restrictive in some cases. Often, execution of a function or method must be allowed, but with limitations on the amount or identity of resources accessed. These access limitations may be explicit, where only certain parameter values are allowed and where function or method calls using other parameter values are rejected. Alternatively, functions or methods may be limited to operating on resources belonging to the application.

Blocking functions or limiting their scope may not completely prevent an application from interfering with another. For example, if an application loops indefinitely, the web server will be prevented from serving other applications at full capacity. Similarly, if an application fills up the web server's storage system, other applications will be prevented from storing data. Service level agreements may require that one application not be able to impair the operation of the web server to the point that the agreed service level for another application is not met. This problem exists in most if not all web based application environments.

For an application server hosting applications created by a third party, network bandwidth used by the applications is also an issue. The hosting company may wish to prevent excessive traffic (e.g. email spam) being originated by a malicious application. For mobile messaging, the application server may have limited bandwidth to send messages due to messaging cost, and one application may use all the capacity, preventing other applications from sending. If the application server's messaging is unrestricted and it is run by a VASP (value added service provider), the VASP may have to pay for excess traffic generated by a faulty application.

Web-based virtual machines configured to execute a number of different applications are an alternative to other existing techniques such as: virtual hosting; Java security management; and clustering with multiple web servers, each dedicated to a single application. More particularly, a web-based virtual machine that provides a sandbox framework to allocate server resources for each application may have several advantages over virtual hosting. First, applications are prevented from interfering with each other, allowing service level guarantees to be made that could not be made with virtual hosting. Second, applications can be prevented from seeing each other's data, solving security problems that could prevent virtual hosting of applications from different sources.

Further, web-based virtual machines may have an advantage over clustered solutions in that multiple applications can be run on a single web server. This results in a savings in hardware as well as a simplification of the overall system requirements and reduction of administration/operational cost.

B. System

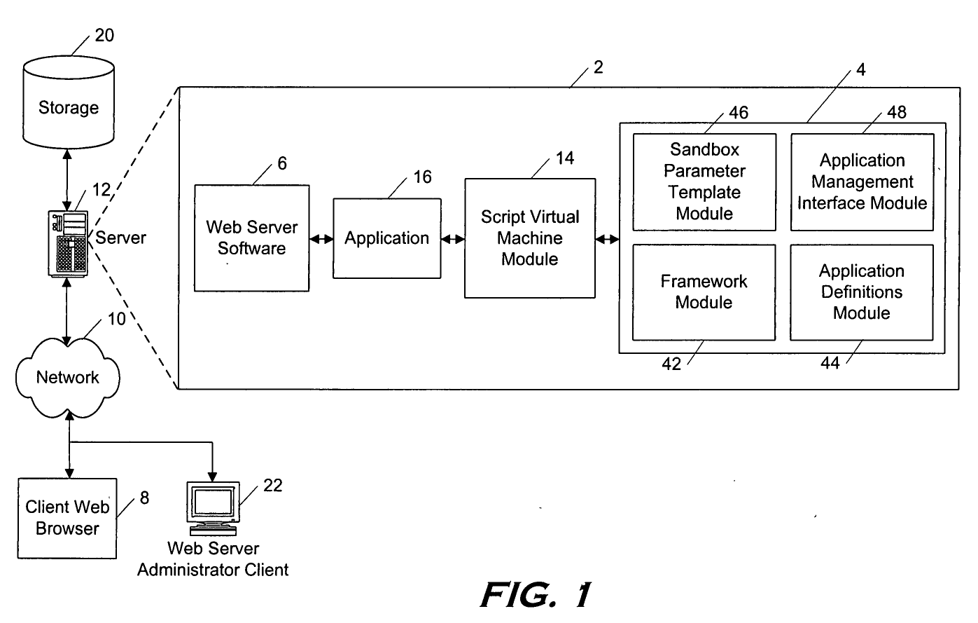

As depicted in FIG. 1, one embodiment of a system 2 according to the present invention provides a sandbox 4 for interoperation with a web server 6 for allocating server resources for a web-based virtual machine. A client web browser 8, which may be hosted on any electronic device, communicates a web request through network 10 to server computer 12. Server computer 12 receives the web request and processes it through web server software 6. The web server 6 comprises a means for identifying software, an application 16, for providing dynamic content for the request. The web server 12 may be coupled to a storage 20.

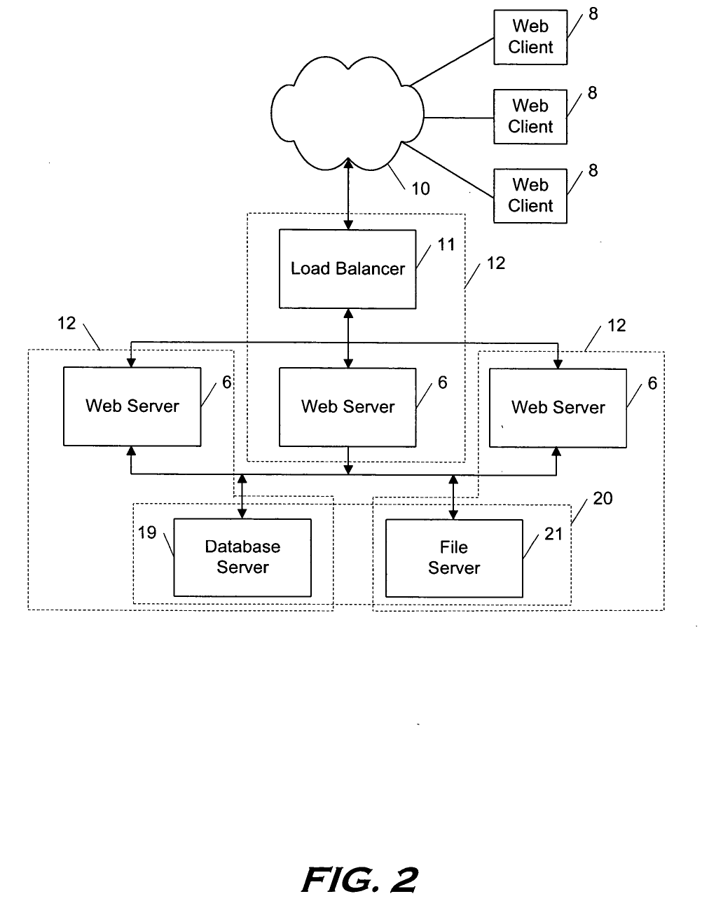

It is to be appreciated that while one embodiment of a system 2 may comprise a single web server 6 process running on a single server computer 12, other embodiments having differing configurations of web server processes and server computers 12 are within the contemplation of the present invention. For example, in another embodiment, a clustered web-server may comprise multiple web servers 6 running on multiple server computers 12. As depicted in FIG. 2, web servers 6 may share resources such as a database server 19 or a file system, provided by, for example, a file server 21. Preferably, load is balanced across all of the web servers 6. An embodiment of the system 2 may comprise multiple sandboxes 4 configured to cooperatively control access to shared resources, insuring no one application 16 exceeds its resource limits across an entire cluster of web servers 6.

FIG. 2 depicts one embodiment of a system 2 adapted to a clustered server environment having a storage 20 comprising a database server 19 and a file server 21. A load balancer 11 distributes requests among a set of web servers 6. In the depicted embodiment, each server computer 12 comprises one web server 6. In addition, in this embodiment one server computer 12 further comprises the load balancer 11, one server computer 12 further comprises a file server 21, and one server computer 12 further comprises a database server 20. In another embodiment, a single server computer 12 comprises each of the load balancer 11, web server 6, file server 21, and the database server 19. In another embodiment, a different server computer 12 comprises each of the web servers 6 in FIG. 2, the load balancer 11, the file server 21, and the database server 19. It is to be appreciated each of the web servers 6, the load balancer 11, the file server 21, and the database 19 may be distributed among any number of server computers 12. Moreover, a load balancer 11 may distribute requests to any number of web servers 6.

In one embodiment, multiple web servers 6 share a single file system by connecting to a file server 21. In one embodiment, the web servers 6 may connect to the file server 21 using the network file system (NFS) protocol. In another embodiment, the web servers 6 may connect to the file server 21 using the server message block (SMB) protocol. The sandbox 4 on each web server 6 may enforce a limit on the amount of filespace allowed for each application 16 across the entire cluster. The amount of filespace may be determined by a resource template. More than one application 16 may share a resource template. The sandbox 4 on each web server 6 may enforce a limit on the number of open files allowed for each application 16 on each web server 6 independently of the other applications 16.

Dynamic content may comprise any response that is generated by execution of a software application 16 at the direction of web server 6. Dynamic content may comprise content produced by the application 16 from, for example, a calculation, data produced from information sent in the request, or from data provided by a database. Dynamic content may also comprise fixed, static data, which may be stored, for example, in a file or a database server 19. This static data may comprise content such as, for example, fixed markup language, graphics, or any other data from a file or a database server 19. Typically, dynamic content comprises a mixture of both static content and content produced in the software code executed at the direction of web server 6. Thus, in one embodiment, when web server 6 determines that the web request is for content that is provided by an dynamic content web page, the server 6 passes the request onto a virtual machine module 14 which executes a script for an application 16.

The script for the application 16 may be selected from a set of application scripts, based on, for example, the URL or virtual host associated with the web request, to perform the web request. A sandbox 4 may place any combination of three types of resources limits on the execution of the application 16: functionality based resource limits, quantitative resource limits, and bandwidth resource limits.

The application 16 preferably comprises one or more scripts, written in a scripting language. The virtual machine module 14 comprises a means for executing the application 14. The virtual machine module 14 may be a runtime execution environment for any computer language used by the application 16 to provide, for example, active web page content, wireless markup language (WML) content, short messaging service (SMS) driven content, or email driven content. Computer languages may include, for example, Java, or scripting languages such as PHP, Perl, or Python. Preferably the virtual machine module executes PHP language scripts. In one embodiment, the virtual machine module 14 may simply be a language interpreter of an application 16 comprising a script or byte-codes resulting from compiling a script. The virtual machine module 14 is configured to communicate with the sandbox 4 to allocate access to the resources of server 6. In one embodiment, the sandbox 4 may be compiled and linked as part of the executable code for the virtual machine module 14.

In another embodiment, a sandbox 4 is provided for the Tomcat web server to enhance the limited capabilities of the Java security manager. Native classes that implement access to resources that are to be allocated, such as file classes, may be modified to call into a framework module 42. In this embodiment, the framework module 42 is preferably implemented in Java.

Another embodiment of a system 2 may comprise a sandbox 4 for CGI applications 16 running on the Apache web server 6. Preferably, to avoid the inefficiency of starting a new operating system process each time a CGI application 16 is executed, a virtual machine 14 may be started for each application 16. For web servers running under the Linux operating system, user mode Linux (UML) may be used to implement the virtual machines 14.

In yet another embodiment of a system 2, the Apache web server is used as a front-end web server for Microsoft IIS Web Server to support an ASP web-based application environment. Any requests for ASP dynamic content are forwarded to an instance (preferably, one per application 16) of the IIS web server running in a virtual machine 14. The virtual machine 14 may be configured per application 16 to control access to resources by application 16.

The sandbox 4 may be comprised of a number of software modules running on a server computer. Preferably, the sandbox 4 modules run on the same server as script runtime module 14. In one embodiment, the sandbox 4 and virtual machine module 14 are executed by the server computer 12 along with the web server 6. It is to be appreciated that each of the modules typically comprises various sub-routines, procedures, definitional statements, and macros. Each of the modules may be separately compiled and linked into a single executable program. The following description of each of the modules is used for convenience to describe the functionality of one embodiment of a system. Thus, the processes that are performed by each of the modules may be redistributed to one of the other modules, combined together in a single module, or made available in, for example, a shareable dynamic link library. Preferably, the modules may be produced using the same computer language as provided by the scripting virtual machine module 14, or the same computer language used to produce the virtual machine module 14. However, it is to be appreciated that the modules may be produced using any computer language or environment, including general-purpose languages such as C or C++, or scripting languages such as PHP, Python, Perl, TCL, or any other language as would be known to one of skill in the art.

In one embodiment, sandbox 4 may comprise a main framework module 42. The framework module 42 comprises a means for limiting access to a resource as specified by the limit of a template. As used herein, a template comprises a set of associations between resources and limits, or allocation, of the resources, in a file or form that thereby defines the resources allocated to an application. Preferably, a template allows parameters such as, for example, the allocation of the quantities of various resources, or availability of certain functionality, to be specified. A template may be applied to a variety of different applications 16.

Framework module 42 configures the virtual machine module 14 and provides resource allocation services to that module. When an application 16 is invoked, framework module 42 communicates with an application definitions module 44. The application definitions module 44 loads the sandbox definitions for the invoked application 16. The applications definitions module 44 comprises a means for associating an application 16 with a template. The application definitions module 44 may load the definitions from storage 20. The framework module 42 may use these definitions to select an appropriate sandbox parameter template. The framework module 42 communicates with the sandbox parameter template module 46 to load a template containing the specific sandbox resource allocation parameters for the application 16. The sandbox parameter module 46 comprises a means for identifying a template for the application 16. The sandbox parameter template module 46 may load the definitions from storage 20.

The sandbox 4 uses a large number of configuration parameters that may vary per application 16. Since hundreds of applications 16 may be hosted on a single web server computer 12, configuration of all parameters per application 16 is error prone. Further, configuration errors may create security problems. The sandbox 4 allows the definition of sets of functional constraints, quantitative resource limitations, and bandwidth limitations. These sets of resource limitations are specified by templates. Each template may be assigned to more than one application 16. Resource templates allow applications 16 to be assigned to different classes, such as light, medium and heavy resource use or trusted and untrusted applications 16. One embodiment of the sandbox 4 provides the following template categories: functionality templates, bandwidth templates, and resource templates.

Both the sandbox parameters templates and the application definitions may be managed through an application management interface module 48. The application management interface module 48 may provide a human-machine interface that allows a web server's administrator 22 to define the templates. The interface module 48 may also provide a user interface to allow the administrator to define application definitions. In one embodiment, the application 16 may be defined in terms of the script to be run. Further, the application definitions may specify IP addresses (virtual hosts) and URLs that invoke the application 16. Finally, the application definitions may relate the resource, functionality, and bandwidth templates to be used by the framework module 42 for the application 16.

In one embodiment, the sandbox framework module 42 may enforce functionality based resource limits by intercepting function calls made in the virtual machine module 14. These functions may correspond to scripting language functions or classes. Preferably, the virtual machine module 14 may be configured so that function calls that are subject to the controls of the framework module 42 are intercepted so that control first passes to the framework module 42. Functions that allocate or release resources, that access restricted functionality, or that send or receive network messages may be intercepted.

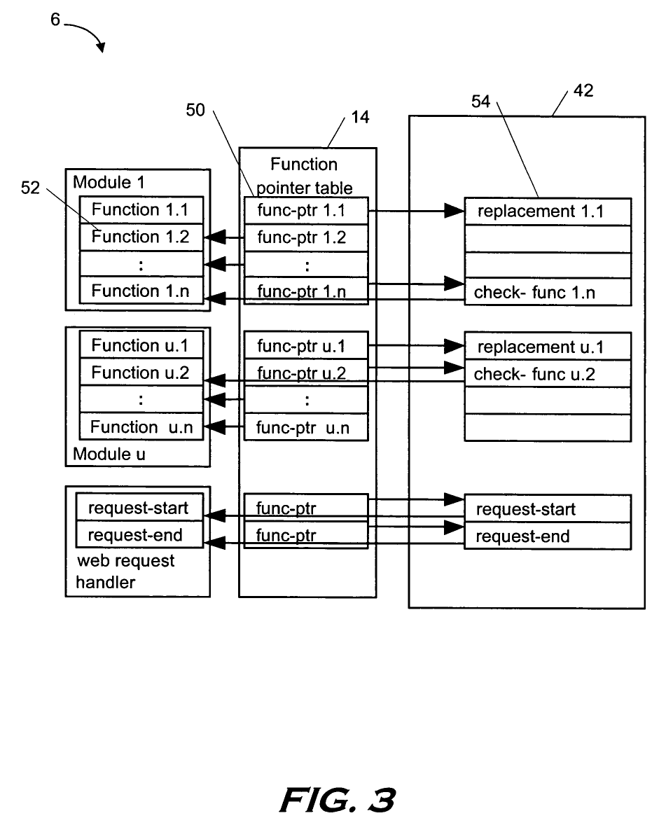

FIG. 3 depicts a set of function pointer tables in one embodiment of the system 2 wherein the virtual machine module 14 and the framework module 42 are executed within the web server 6 as modules. In this embodiment all functions provided by the script virtual machine 14 to be called from an application 16 are routed through a function pointer table 50. The function pointer table 50 in the virtual machine module 14 may contain the address of the code to be executed when a particular function is invoked by an application 16. Function pointers that are not affected by the framework module 42 are left unmodified, and thus point to the default code for that function, which may reside, for example, in a module 52. Function pointers that are affected by the framework are replaced with function pointers into a function table 54 of framework module 42. Framework module 42 may either replace those functions, or invoke the original function via its pointer after determining whether the application 16 is allocated sufficient resources to perform the function.

Preferably, the framework module 42 controls whether or not an application 16 may use each function or class provided by the virtual machine module 14. The functionality constraints may entirely prevent an application 16 from using some functions or classes.

In one embodiment, the framework module 42 may also intercept functions or methods to ensure that the application 16 may only use its own resources, such as files in its own file space. This may comprise checking the parameters of the function call. This type of resource allocation differs from that involving quantities of resources such as memory in that the identity of resources is monitored rather than the quantity. If an application 16 attempts to use resources to which it is not entitled, the framework 42 may deny the request or prevent the application 16 from running. Otherwise, the framework module 42 can call the web server's function or method on the application's behalf using a saved copy of the original function pointer.

In one embodiment of the framework module 42, functions or methods allowing access to a database server 19 that is coupled to web server 6 are intercepted. Attempts to make a connection to a database server 19 with a user name other than the application's own are blocked by the framework 42, unless the application 16 is trusted to make them. The framework module 42 may provide the database password of the application 16 on its behalf, removing the need to store the password insecurely in the application's source code or data files.

In one embodiment, multiple web servers 6 connect to a database server 19. The database server 19 enforces a limit on the number of database connections allowed for each application 16 across the entire cluster. Different applications 16 may be allowed different numbers of connections. The number of database connections may be determined by a resource template. More than one application 16 may use a given resource template.

In one embodiment, when new functions or classes are added to the application environment (e.g., by upgrading the web server software), the framework module 42 disables access to them by default. The new functions or classes are automatically added to the human-machine interface provided by the application management interface module 46 that allows the functionality templates to be configured.

Quantitative resource limitations may comprise limits on the quantity of server resources that an application 16 may consume. These may include, for example, the number of open files, the amount of CPU time that the application 16 may consume, or the amount of time that an application 16 may spend performing a specific operation. For example, if an application 16 attempts to open too many files at one time, the sandbox 4 may return an appropriate error to the application 16. Alternatively, the sandbox 4 may be configured to return an error directly to the web server 6, whereby the application 16 is terminated and an access violation page is returned to the client web browser 8. As described herein with respect to limitations on functional access, these resource allocation measures may be implemented by intercepting resource-accessing functions. After intercepting the functions, framework module 42 checks actual resource use against the resource limits specified in the resource templates.

Quantitative resource allocation may also be performed for resources that are not associated to a single function call. For example, for time-limited operations, one function call or a set of function calls may have to be completed within a certain time limit. In one embodiment, when using time limited operations, a timer may be started in the framework module 42 before starting the operations and is cancelled when the operations are complete. If the timer expires before the operations are complete, the framework module 42 will block further execution on the operations and will return an error code, or error message. The framework module 42 templates can specify time limits per operation and for processing an entire client request. These parameters may be configured per application 16.

Consumable server 6 system resources may also be allocated. In addition to static limits (such as number of open files), the framework module 42 may also handle allocation of resources that are consumed over time.

One example is CPU time. Every web client request requires processing on the web server 6, which consumes some CPU time. The framework module 42 may monitor CPU time consumed by an application 16 and can compare consumption within a certain time period with the limit specified in the resource template. In one embodiment, if the application 16 reaches its limit during the time period, the application 16 may be disabled. An application 16 may be disabled either for a specified time or indefinitely until reenabled by a web server administrator.

Many resource limitations described herein are static, i.e. once a level of access is granted to a resource, access remains the same until changed by the administrator. As described above, the sandbox 4 may also monitor use of consumable resources and allocate those resources among applications 16. In one embodiment, tokens representing resources that are consumed by an application 16 are stored in a logical “bucket” in the framework module 42. The framework module 42 monitors the use of resources by the application 16 and deducts the tokens from the application's bucket. When an application's bucket is empty, the framework module 42 prevents the application 16 from running. In one embodiment, a bucket may be implemented as a simple integer count of the number of tokens available for consumption.

One example of such a resource is CPU time consumed by an application 16. The framework module 42 may limit the number of available CPU seconds allocated to a given application 16. In one embodiment, each second of time spent running requires a token. When the application 16 has run for one second, a token is consumed from the application's CPU time bucket. When the bucket is empty, the framework module 42 prevents the application 16 from running.

In one embodiment, the framework module 42 may periodically refill resource buckets, allowing a resource to be consumed at a fixed rate. The administrator may also refill buckets manually, allowing a variable rate of consumption. Use of resources may be tracked over time by monitoring token consumption, and may be billed to the owner of the application 16. These methods allow different charging schemes between the owner of the web server 6 and the application owner to be implemented. In one embodiment, the amount of resources may be set indirectly based on a cost per unit of resources and a specific amount of funds made available for resources.

The third type of constraint, bandwidth constraint, is conceptually just another form of quantitative resource constraint. Bandwidth is the rate at which network traffic can be originated by an application 16 in the runtime virtual machine module 14. The sandbox 4 may allocate the total available bandwidth to specific applications 16. In one embodiment, messages to be sent by an application 16 are put in a queue. The messages may then be removed from the queue and sent out at a rate controlled by the sandbox 4. If the application 16 exceeds the allowed rate for a certain amount of time, the upper limit on the queue will be reached and the sandbox 4 may discard further messages.

Bandwidth management may be used to prevent an application 16 from sending (originating) too many messages. However, bandwidth management may also be used to optimize use of limited bandwidth communication channels. In one embodiment, the queuing mechanism described above is used to provide guaranteed minimal bandwidth to each application 16. The sum of the maximum bandwidth guaranteed to all applications 16 should not exceed the maximum allowed bandwidth of the web server's messaging channel(s). Generally, in practice, it is highly unlikely that all applications will try to use or exceed their maximum guaranteed bandwidth at the same time. In any time period, spare bandwidth may be calculated as:
BW_{Spare}=BW_{MaxAllowedWebServer}−Σ(min(BW_{MaxAllowedApp}, BW_{CurrentlyRequiredApp})).
If spare bandwidth is available and some applications 16 attempt to exceed their maximum guaranteed bandwidth, the sandbox 4 may allow fair use of this spare bandwidth by selected applications 16 as long the overall messaging bandwidth within a fixed time is not exceeded. In one embodiment, spare bandwidth is divided between applications 16 using a weighted distribution. In another embodiment, spare bandwidth is divided equally among requesting applications 16.

Different instances of sandbox 4 corresponding to different instances of web server 6 may have different sets of templates. Applications 16 are typically developed using one specific set of templates. In one embodiment, a complete application 16, along with resource templates may be moved to a new sandbox 4 environment. However, templates of the application 16 set may not be available, or configured for use, in the new sandbox 4. The framework 42 may provide a mechanism that finds the closest matching set of templates on the new sandbox 4 when the exact template set used to test the application 16 is not available. In one embodiment, the framework 42 finds the closest matching set of templates that is the most restrictive set that includes all of the capabilities that were used during the application's development, i.e. the matching templates are no more limiting than the templates used to test the application 16. Use of this method gives the greatest likelihood that the application 16 will work reliably.

In another embodiment, quantitative resource and bandwidth templates are compared using the method of least-squares-fit, where for each resource or bandwidth constraint, the numeric value from the template used to develop the application 16 is compared with the corresponding constraint from the template under consideration. The difference between the two is squared and added to a running total. The template for the sandbox 4 with the lowest total is the best fit and thus the closest match. The application management interface module 48 may present multiple choices to the administrator. The choice to save the templates with which the application 16 was developed may be given.

Preferably, the sandbox 4 implements resource limitations transparently and does not typically require any change in the application 16. As long as the application 16 does not exceed its resource limitations, it will operate as it would if the sandbox 4 were not present. If an application 16 exceeds its resource limitations, the framework module 42 may terminate the associated request and send an access violation error to the web server 6, which may return an access violation page the client web browser 8. In this case, the application 16 need not be modified.

Some applications 16 may require that they handle errors returned by the web server 6 in order to operate correctly. Some of these errors may relate to underlying operating system or web server resource limits. To facilitate the execution of existing scripts in the sandbox 4, framework module 42 may return error codes, or error messages, corresponding to those underlying errors. In language environment that use exceptions, like Java, the framework module 42 may throw an exception. For example, the file open function of web server 6 returns an error when too many files opened by the web server 6. The framework module 42 may enforce a template defined open file limit on each application 16. Thus, continuing the example, the framework module 42, may generate an error code corresponding to the underlying error code if there are too many files opened by the application 16 as determined by framework 42. Thus, so long as the application 16 is prepared to handle the error, it may not need to be changed to run correctly in the sandbox 4.

Applications 16 running on a web server 6 may be implemented using different programming languages, such as PHP or Java. Embodiments of the sandbox 4 may provide the checking and monitoring functions for different application programming languages in parallel. It is to be appreciated that resource and bandwidth templates may be independent of the programming language in which the application 16 has been developed.

It is to be appreciated that other embodiments of the sandbox 4 may allocate resources without intercepting function calls. For example, in one embodiment, the sandbox 4 may passively monitor the use of resources. Passive monitoring may comprise monitoring the use of resources by an application without enforcing the limits on the application 16 as the resource is accessed. For example, in one embodiment, rather than intercepting calls to functions that use resources, the sandbox 4 may compare the use of resources to the limits associated with an application 16 only at fixed checkpoints, such as, for example, before and after processing a request. Applications 16 that exceed their usage of a resource may then be disabled. In another embodiment, the sandbox 4 may check resource use periodically. In yet another embodiment, the sandbox 4 may compare resource usage to the limits associated with an application 16 before and after requests and by performing periodic comparisons.

C. Method

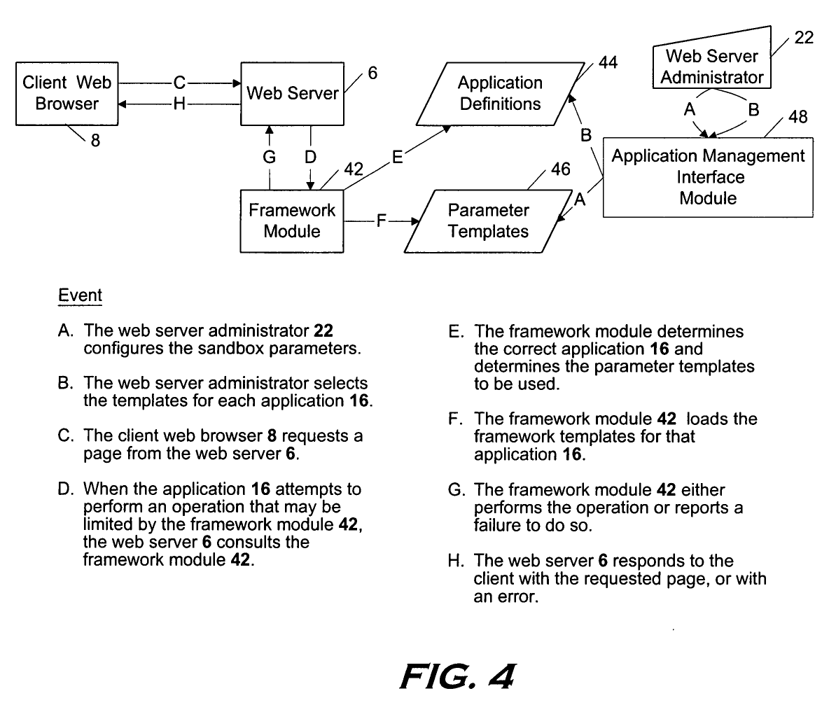

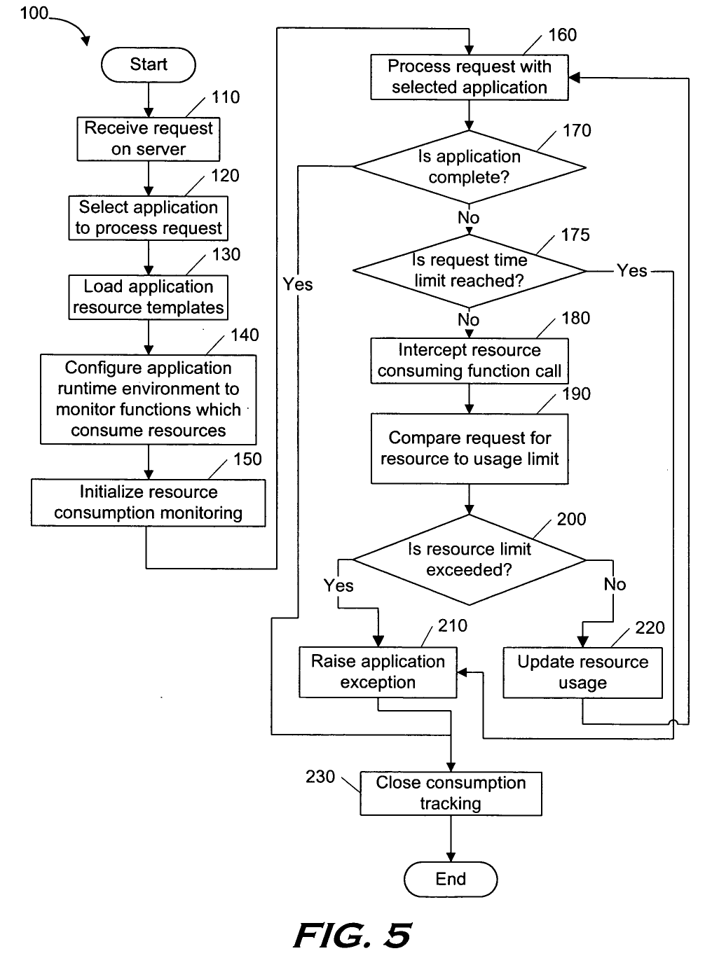

FIG. 4 illustrates the general flow of information between components of one embodiment of a method for allocating server resources on a server computer 12. FIG. 5 is a flow chart that depicts in more detail one embodiment of this method. This method is embodied within code executed by the server computer 12, and is invoked when a request is received from a web browser 8. In state 110, the web request is received on the web server 6 executing on server computer 12.

In other embodiments, applications 16 may consume resources when not directly responding to a request. In one embodiment, a persistent thread for an application 16 may be activated in response to a signal, for example, a timer. In other embodiments, applications 16 may signal the start of persistent threads of execution in the virtual machine 14, which may then continue to consume resources after the request has completed. In another embodiment, separate limits are defined in the resource template for persistent threads of the application 16. In another embodiment, the sandbox 4 deducts the resources consumed by signaled or persistent threads from the total resources allocated to the application 16 per request. Thus, for example, if an application 16 is allocated 5 megabytes (MB) of memory, and a persistent thread for the application is consuming 3 MB, the application 16 is limited to consuming a further 2 MB of memory in responding to a request.

Proceeding to a step 120, the web request is analyzed and an application 16 selected. Preferably, the application 16 is selected based on the URL. More preferably, the application 16 is selected based on a host name or IP address in the URL, from a portion of the path name of the script, or from a combination of the two.

Next at a step 130, the resource templates for the selected application 16 are loaded. In one embodiment, this comprises first loading an application definition, and then loading the correct resource templates based on that definition.

Different web servers 6 may have different sets of templates available. In particular, for web servers 6 running on different server computers 12, it may be advantageous for the sandbox 4 to provide a different set of templates. Thus, an application may be developed on a first web server 6 using the templates of the first sandbox 4, and then deployed on a second web server 6. If the sandbox 4 on second web server 6 does not provide that template, the second sandbox 4 preferably selects a template to use that allows allocates to the application 16 at least the resources that would have been allocated by the template on the first sandbox 4.

Moving on to a step 140, the sandbox 4 uses the resource templates to configure the application's runtime environment, such as the virtual machine module 14, in which the sandbox 4 may monitor functions which consume resources. In one embodiment, the application runtime environment comprises a script virtual machine module 14 for executing an application 16 written in a scripting-type language such as, for example, PHP.

Proceeding on to a step 150, the framework module 42 initializes the resource consumption monitoring data for the application 16. Preferably, this comprises recording the current resource usage of the application 16, determining the current time, and starting a timer that will expire if the maximum time for the request is exceeded.

Next, at a state 160, the selected application 16 is processed on the server computer 12. Preferably, the code, or byte codes, associated with the application 16 are executed in the virtual machine module 14 until a function call that has been intercepted is reached. When an intercepted function call is reached, method 100 moves to a state 170, where, if the function call indicates an exit, or end of process, the method 100 proceeds to a step 230 to close consumption tracking. Otherwise, method 100 proceeds to state 175, where the timer started in step 150 is checked to see whether it has expired. If it has expired, method 100 proceeds to the error state 210.

Otherwise, method 100 proceeds to a state 180 where the function call is intercepted by the framework module 42. Next at a state 190, based on information that, preferably, includes the function being called and the parameters to the function call, the framework module compares the request for a resource to the corresponding parameter in the appropriate template for the application 16. The requested resource may be inherent to the function call, e.g. the functionality accessed is itself a restricted resource. Alternatively, a parameter to the function call may be examined to determine the identity, e.g. a file name, or quantity, e.g. an amount of memory to allocate.

Moving on to a step 200, if the limit specified in the module is reached, processing of method 100 proceeds to an error state 210. If the resource is a functionality type resource, then the limit is considered to be reached and processing moves to the error state 210 if application functionality template does not allow the particular functionality for the application 16. Otherwise, method 100 moves on to step 220 where the resource usage of the application 16 is updated, if appropriate. Moving on from step 220, the application 16 returns to step 160.

If an application 16 has attempted to exceed its resource limits, then method 100 proceeds to a state 210. At state 210, in one embodiment, an error may be returned to the application 16. In some scripting languages this may be performed by raising an exception to be handled by the application 16. In another embodiment, the application 16 is terminated and the error returned to the web server 6. In another embodiment, the resource template determines which of these behaviors to use on a per resource basis.

After the application 16 has completed processing the request, from step 170, or after an error at step 210, processing proceeds to a step 230. At step 230, the sandbox 4 may clean up any internal state. Preferably, this may include canceling the request timer, determining the amount of time spent executing the request, and deducting the corresponding number of tokens from the application's bucket. In some embodiments, information relating to resources consumed by an application 16 may be stored into storage 20 to allow resource limitations to be applied cumulatively across multiple invocations of an application 16. Method 100 then proceeds to an end state.

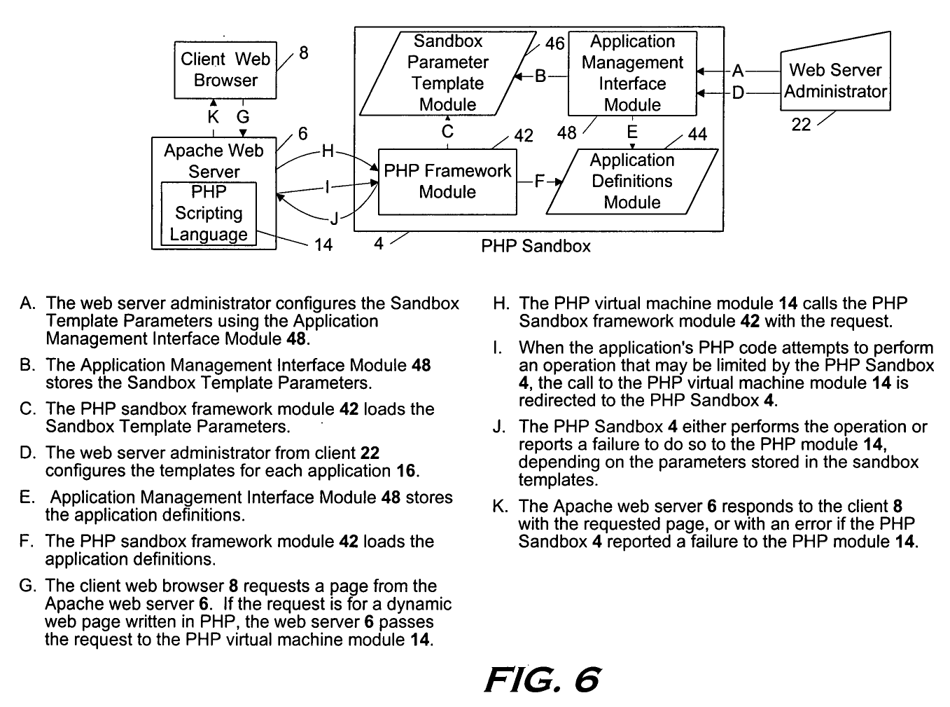

FIG. 6 illustrates the general flow of information in one preferred embodiment of a sandbox 4 that is direct to the PHP scripting language. The virtual machine module 14 is based on the interpreter for the PHP scripting language. Preferably, the framework module 42 configures the function tables of the PHP virtual machine module 14 as depicted in FIG. 3 to intercept PHP function calls that are associated with resource usage. Thus, as the PHP scripts associated with an application 16 are executed by the virtual machine module 14, resource associated functions are intercepted by the framework module 42 in accordance with an embodiment of the method depicted in FIG. 5.

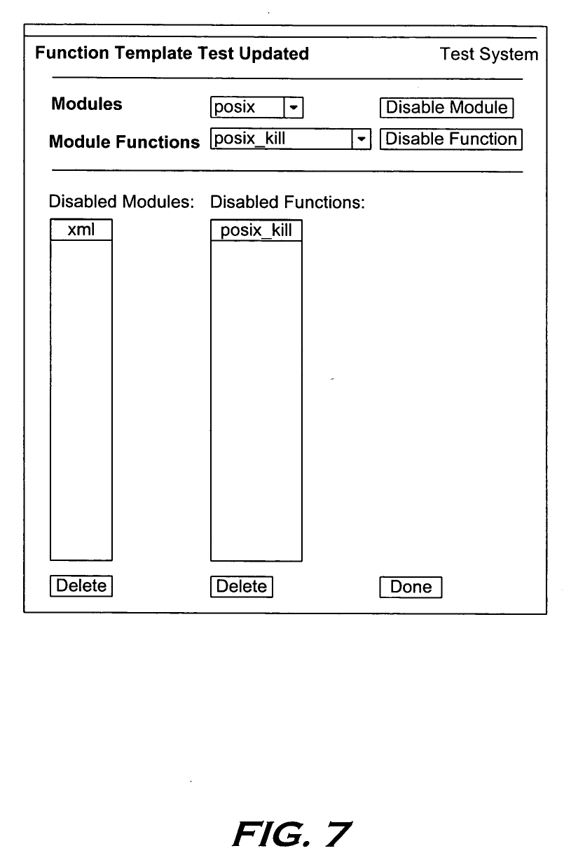

The application management interface module 48 may provide a web based human-machine interface to allow the web server administrator client 22 to configure sandbox template parameters and application definitions. FIG. 7 is screen shot depicting a web-based interface page that allows a function template to be changed as provided by one embodiment of an application management interface module 48. On the depicted configuration page, “test” is the name of the template. “Modules” is a drop-down list of the modules that can be disabled. The “Disable Module” button disables the module currently selected from the list. “Functions” is a list of the functions in the currently selected module. The “Disable Function” button disables the function currently selected from the list. “Disabled Modules” and “Disabled Functions” display the modules and functions currently disabled. Highlighting a module or function name in either of these text boxes and pressing the “Delete” button below it will remove the module or function from the disabled list.

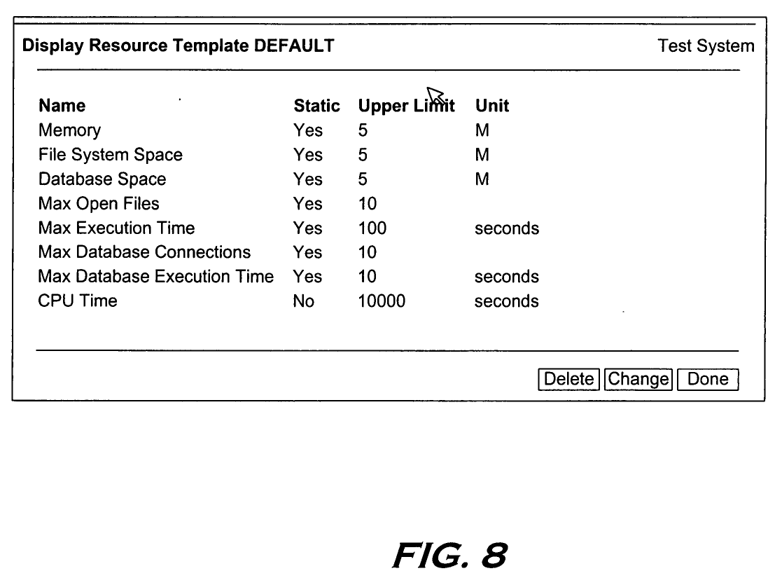

FIG. 8 is a screen shot depicting a web-based interface page that allows a resource template to be changed as provided by one embodiment of the application management interface module 48. On the figure, “DEFAULT” is the name of the template (in this case, the default template). The “Name” column lists the names of the resources. The “Static” column indicates whether the resource is a fixed resource (Yes) or a resource that can be consumed over time (No). “Upper Limit” is the upper limit for the resource and “Unit” specifies the units (M indicates megabytes, no unit indicates that the resource is a count).

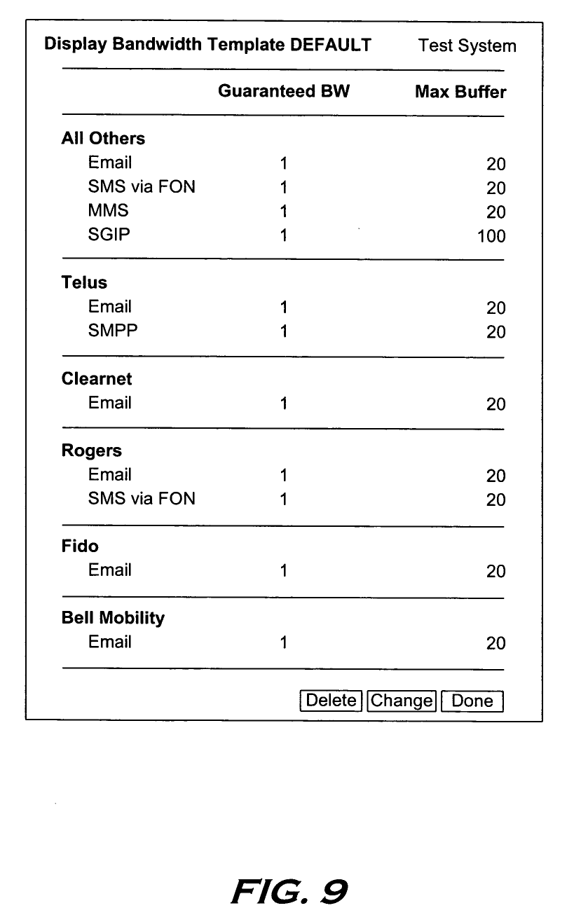

FIG. 9 is a screen shot depicting a web-based interface page that allows a bandwidth template to be changed as provided by one embodiment of the application management interface module 48. On this figure, “DEFAULT” is the name of the template (in this case, the default template). The first column identifies the transport type (e.g. Email). This is the protocol used to transport the messages. The rows are grouped by provider (e.g. Telus). This is the provider of the messaging services accessed via the transports. The “Guaranteed BW” column gives the guaranteed number of message per second that can be sent. The “Max Buffer” column gives the maximum number of messages that will be queued up when the guaranteed bandwidth is exceed before the sandbox 4 may begin discarding messages.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

1. A web server system, comprising:
a server computer having installed thereon a web server and a plurality of applications that interoperate with the web server to service requests from web browsers;
a plurality of templates, each template being associated with one or more of the applications, and specifying resource usage restrictions for the execution of such applications, such that different resource usage restrictions are placed on different applications;
an application framework that runs on the server computer in association with the web server and enforces the resource usage restrictions specified by the templates; and
an application management interface that provides functionality for an administrator to edit the plurality of templates, and to create new templates, to control execution of the plurality of applications on the server computer.

2. The web server system of claim 1, wherein the application framework enforces the resource usage restrictions, at least in part, by intercepting function calls made to the web server by the applications.

3. The web server system of claim 1, wherein the application framework enforces the resource usage restrictions in aggregate within a cluster of server computers.

4. The web server system of claim 1, wherein the templates specify resource quantity limits for the applications, and the application framework monitors resource usage by the applications over time to enforce the resource quantity limits.

5. The web server system of claim 1, wherein the application framework additionally prevents an application from accessing resources that have been allocated to another application.

6. The web server system of claim 1, wherein the application framework controls functional resource usage by the applications to enforce defined application functional access limits.

7. The web server system of claim 1, wherein the application framework controls network bandwidth usage by the applications to enforce defined bandwidth allocations.

8. The web server system of claim 1, wherein the application framework makes calls to the web server on behalf of the applications.

9. The web server system of claim 1, wherein the application framework monitors resource usage of the applications at least in part by maintaining token counts for an application, wherein each token represents a quantity of server resources that may be used by the application.

10. The web server system of claim 1, wherein the application framework is responsive to a web server request that invokes an application by loading at least one template associated by that application.

11. A method for allocating resources in a server computer comprising:
receiving a web server request from a client for dynamic content, wherein the web server request comprises a URL;
identifying an application for generating the dynamic content, wherein the application is identified based, at least in part, on the URL;
identifying a template for the application, wherein the template associates at least one resource with a limit; and
executing the application in a virtual machine configured to allow resource accessing function calls to be intercepted;
intercepting resource accessing function calls;
granting access to the resource if the limit is not exceeded; and
tracking resource usage.

12. The method of claim 1, further comprising:
terminating the application and returning an error to the client when the limit is exceeded.

13. The method of claim 1, further comprising:
returning an exception to the application when the limit is exceeded.

14. The method of claim 1, wherein the dynamic content comprises information from a database.

15. A method for allocating resources in a server computer comprising:
receiving a request from a client;
identifying an application based, at least in part, on the request;
identifying at least one association of a resource with a limit specific to the application; and
executing the application in a virtual machine configured to limit access to the resource as specified by the limit.

16. The method of claim 15, wherein the request comprises a web request.

17. The method of claim 15, wherein the virtual machine is configured to execute a plurality of applications wherein at least two of the plurality of applications are identified with a different limit for the resource.

18. The method of claim 15, further comprising:
terminating the application and returning an error to the client when the limit is exceeded.

19. The method of claim 15, further comprising:
returning an exception to the application when the limit is exceeded.

20. The method of claim 15, wherein the dynamic content comprises information from a database.

21. The method of claim 15, further comprising:
defining the association of a resource with a limit through a web-based human-machine interface.

22. The method of claim 15, wherein the resource comprises a function performed by the server.

23. The method of claim 22, wherein the limit for a function represents whether the function may be accessed.

24. The method of claim 22, further comprising:
automatically determining the limit on the function if a limit has not been specified for an application.

25. The method of claim 24, wherein automatically determining the limit on the function if a limit has not been specified for an application comprises disabling new functions added to the runtime environment.

26. The method of claim 24, wherein automatically determining the limit on the function if a limit has not been specified for an application comprises enabling new functions added to the runtime environment.

27. The method of claim 22, wherein limiting a function is based on an application specific validation of parameters to the function.

28. The method of claim 15, wherein limiting access comprises enforcing a limit on a quantity of the resource.

29. The method of claim 28 wherein limiting access to a resource comprises:
monitoring the quantity of the resource that is consumed.

30. The method of claim 15, wherein the resource comprises processor time.

31. The method of claim 30, wherein the limit to processor time is cumulative across a plurality of requests to the application.

32. The method of claim 15, wherein the resource comprises bandwidth.

33. The method of claim 15, wherein the resource comprises the open files.

34. The method of claim 15, wherein the resource comprises the file space.

35. The method of claim 15, wherein the resource comprises the open database connections.

36. The method of claim 15, wherein the resource comprises memory.

37. The method of claim 15, wherein the resource comprises an amount of time to respond to the request.

38. The method of claim 15, wherein executing the application comprises:
intercepting a function call in the runtime environment associated with accessing of the resource; and
rerouting the function call based on the application resource limit.

39. The method of claim 38, wherein the resource is determined by a parameter of the function call.

40. The method of claim 15, wherein the virtual machine comprises a PHP interpreter.

41. A method for selecting a substitute resource template for an application, comprising:
identifying a template defining a limit on at least one resource in a first server associated with an application;
comparing the associated template to a set of available templates provided for a second server; and
selecting the available template that is a closest match to the associated template.

42. The method of claim 41, wherein the available template defines a limit that is no more limiting than the limit of the associated template.

43. The method of claim 41, selecting the available template having a closest match comprises calculating a least-squares measure of the available template to the associated template.

44. A system for allocating resources in a server computer comprising:
a virtual machine module configured to execute a computer application associated with a server request;
an application definitions module configured to identify a mapping of at least one resource template with the application;
a parameter template module configured to identify a template associated with the application, wherein the template associates at least one resource with a limit;
a framework module configured to intercept function calls of the application that are associated with the resource and to limit access to the resource as specified by the limit of the template.

45. The system of claim 44, wherein the application definitions module is configured to identify the mapping of at least one resource template with the application from a plurality of mappings of applications to templates, wherein at least a first application is mapped to a different template that at least a second application.

46. A system for allocating resources for processing of a client request to a server computer, comprising:
means for identifying an application based, at least in part, on the request;
means for identifying at least one association of a resource with a limit for the application;
means for executing the application; and
means for limiting access to the resource as specified by the limit.

47. A method for allocating resources in a server computer comprising:
receiving a signal to activate an application;
identifying an application based, at least in part, on the signal;
identifying at least one association of a resource with a limit specific to the application; and
executing the application in a virtual machine configured to limit access to the resource as specified by the limit.
